(19) United States
(12) Patent Application Publication
(10) Pub. No.: US 2026/0014776 A1
(43) Pub. Date: Jan. 15, 2026

(54) BONDING PANEL MATERIAL FOR AUTOMOTIVE DOOR MOLDINGS AND MANUFACTURING METHOD THEREOF

(71) Applicants: DSP Co., Ltd., Gimhae-si (KR); DSP INNOVATION Co., Ltd., Ansan-si (KR)

(72) Inventors: Jin Hyung KIM, Seoul (KR); Ji Hoon KIM, Seoul (KR)

(73) Assignees: DSP Co., Ltd., Gimhae-si, Gyeongsangnam-do (KR); DSP INNOVATION Co., Ltd., Ansan-si, Gyeonggi-do (KR)

(21) Appl. No.: 19/260,650

(22) Filed: Jul. 7, 2025

(30) Foreign Application Priority Data
Jul. 15, 2024 (KR) 10-2024-0092886

(51) Int. Cl. B32B 15/01; B32B 7/12

(52) U.S. Cl. CPC B32B 15/011; B32B 7/12; B32B 2250/02; B32B 2307/7376; B32B 2311/30; B32B 2605/00

(57) ABSTRACT

A bonding panel material for automotive door moldings according to the present disclosure includes a surface material made of a 300 series stainless steel panel material manufactured to a preset thickness; a base material made of a 400 series stainless steel panel material that is attached to a back surface of the surface material in a flat shape and has magnetism; and an adhesive layer positioned between the surface material and the base material to bond the surface material and the base material to each other, in which the surface material has a relatively greater elongation than the base material.

### CROSS-REFERENCE TO RELATED APPLICATION

This application claims the benefit of priority under 35 U.S.C. § 119(a) to Korean Patent Application No. 10-2024-0092886 filed on Jul. 15, 2024, the entire contents of which are incorporated herein by reference.

### BACKGROUND

### (a) Technical Field

The present disclosure relates to a bonding panel material for automotive door moldings and a manufacturing method thereof, and more particularly, to a bonding panel material for automotive door moldings having excellent corrosion resistance and processability by bonding stainless steels having different characteristics, and a manufacturing method thereof.

### (b) Background Art

In general, stainless steel automotive door moldings are manufactured into door frames, door belts, quarter glasses, etc. by slitting stainless steel materials to specifications, and forming, bending, and pressing the stainless steel materials.

Such finishing materials are intended to utilize unique physical properties of the materials, and as a part directly exposed to people's eyes, have a great influence on durability, corrosion resistance, glossiness, and aesthetics of color.

In addition, recently, in the case of the automotive door moldings, glossy products with mirror-processed stainless steel surfaces, semi-glossy products with embossing processing, and color products with various coating processes are applied.

Stainless steel has various series depending on the manufacturing process, but here, austenite series (hereinafter referred to as 300 series stainless steel) with high chromium and nickel content and non-magnetism, and ferrite series (hereinafter referred to as 400 series stainless steel) with high chromium content and magnetism are mainly used.

Specifically, 300 series stainless steel has excellent corrosion resistance and processability, but there is a problem that it should go through a separate mirror process for surface gloss, and there is an inconvenience that magnetism may not be used when bonding door frames, door belts, PVC, TPC, etc., which are post-processing, or when injecting quarter glass inserts.

Since 400 series stainless steel may obtain the desired surface gloss by adding a skin pass process, and has magnetism, it has an advantage in post-processing, but it has low tensile strength and elongation, so it is weak to processing shock, and thus there is a problem that cracks occur during forming or bending.

In addition, 400 series stainless steel has poor corrosion resistance, so there are problems such as surface discoloration. Therefore, a method for solving these problems is required.

### SUMMARY OF THE DISCLOSURE

The present disclosure is devised to solve the problems of the above-described conventional technology, and an object of the present disclosure provides a bonding panel material for automotive door moldings capable of securing corrosion resistance and processability and having magnetism by utilizing the advantages of both 300 series and 400 series stainless steels by bonding the 300 series stainless steel, which has relatively high tensile strength and elongation, as a surface material to an upper surface of a base material made of the preset 400 series stainless steel, and also increasing productivity during post-processing.

The problems of the present disclosure are not limited to the above-described problems, and other problems that are not described may be obviously understood by those skilled in the art from the following description.

To achieve the above objects, a bonding panel material for automotive door moldings of the present disclosure includes: a surface material made of a 300 series stainless steel panel material manufactured to a preset thickness; a base material made of a 400 series stainless steel panel material that is attached to a back surface of the surface material in a flat shape and has magnetism; and an adhesive layer positioned between the surface material and the base material to bond the surface material and the base material to each other, wherein the surface material has a relatively greater elongation than the base material.

In addition, the surface material may expand when the base material is formed or bent toward inwardly, and maintain its surface condition without damage such as crack occurrence.

In addition, the surface material may be made of austenitic stainless steel, and the base material may be made of ferritic stainless steel.

In addition, the adhesive may be applied to at least one surface of the base material or the surface material or may be attached in a film form.

In addition, the surface material may have an elongation of approximately 50% or more and may be made of a material that is relatively more resistant to processing shock than the base material.

In addition, the surface material may adjust gloss and color through a separate surface treatment.

In addition, the surface material may be made of any one among the stainless steel grades STS304, STS304L, STS304J1, STS316, or STS316L, and the base material may be made of any one among the stainless steel grades STS409, STS411, STS430, STS436, or STS441.

In addition, the surface material may be formed to have a thickness of 0.1 mm to 0.3 mm, and the base material may be formed to have a thickness of 0.3 mm to 0.7 mm.

Meanwhile, to solve the above problems, a manufacturing method of a bonding panel material of the present disclosure includes the steps of: (a) manufacturing a base material with a 400 series stainless steel panel material; (b) preparing a surface material with a 300 series stainless steel panel material; (c) forming an adhesive layer by applying an adhesive to either a back surface of the surface material or an upper surface of the base material; (d) positioning the adhesive layer between the surface material and the base material and bonding the surface material and the base material to each other to manufacture the bonding panel material; and (e) processing the bonding panel material into a preset shape.

In addition, the bonding panel material bonded in the step (d) may have a bonding force of 200 N or more.

In addition, in the step (b), at least one of a gloss control process for controlling a gloss of the surface material and a coloring control process for controlling a color of the surface material is performed.

In addition, the surface material may be wound in a roll type during the gloss control process or the coloring process.

According to the bonding panel material for automotive door moldings and the manufacturing method thereof of the present disclosure for solving the above-mentioned problem,
by manufacturing the bonding panel material by bonding the base material made of the 400 series stainless steel panel material with magnetism and the surface material made of the 300 series stainless steel panel material without magnetism, it is possible to prevent cracks from occurring on the processed surface through the high tensile strength and elongation of the surface material during the forming, bending, and press processing of the automotive door moldings, and simply perform the molding manufacturing process through the base material having magnetism.

The effects of the present disclosure are not limited to the above-described effects, and other effects that are not described may be obviously understood by those skilled in the art from the claims.

### BRIEF DESCRIPTION OF DRAWINGS

FIG. 1 is a diagram illustrating a structure of a bonding panel material for automotive door moldings according to an embodiment of the present disclosure;

FIG. 2 is a diagram illustrating a state in which a surface material and a base material of the bonding panel material for automotive door moldings according to an embodiment of the present disclosure are bonded with an adhesive;

FIG. 3 is a diagram illustrating a state in which a 300 series stainless steel panel material is bent in the bonding panel material for automotive door moldings according to an embodiment of the present disclosure;

FIG. 4 is a diagram illustrating a state in which a 400 series stainless steel panel material is bent in the bonding panel material for automotive door moldings according to an embodiment of the present disclosure;

FIG. 5 is a diagram illustrating a difference between a product made of the bonding panel material for automotive door moldings according to an embodiment of the present disclosure and a product made of a conventional 400 series stainless steel single panel material by bending each of the products;

FIG. 6 is a diagram illustrating a detailed state in which the bonding panel material for automotive door moldings according to the embodiment of the present disclosure is deformed during forming or bending;

FIG. 7 is a diagram illustrating the results of an adhesive strength test of the bonding panel material according to the embodiment of the present disclosure;

FIG. 8 is a diagram illustrating the entire manufacturing process of a bonding panel material for automotive door moldings according to an embodiment of the present disclosure in sequence;

FIG. 9 is a diagram illustrating a detailed process of manufacturing a surface material in the manufacturing process of FIG. 8; and

FIG. 10 is a schematic diagram of an apparatus for manufacturing a bonding panel material for automotive door moldings of FIG. 9.

### DETAILED DESCRIPTION

In this specification, when a component (or region, layer, section, etc.) is referred to as “being on”, “connected to”, or “coupled to” other component, it means that the component may be directly disposed/connected/coupled to the other component, or a third component may also be disposed therebetween.

Identical drawing numbers refer to identical components. Also, in the drawings, the thickness, ratio, and dimension of the components are exaggerated for the purpose of effectively explaining the technical contents.

“And/or” includes any combination of one or more of associated components that can be defined.

The terms such as ‘first’ and ‘second’ may be used to describe various components, but the components are not to be construed as being limited to the terms. The terms are used only to differentiate one component from other components. For example, a first component may be named a second component and the second component may also be similarly named the first component, without departing from the scope of the present disclosure. Singular expressions are intended to include plural expressions unless the context clearly indicates otherwise.

Additionally, the terms such as “below,” “lower,” “above,” and “upper,” are used to describe the relationships between components shown in the drawings. These terms are relative concepts and are described based on the directions indicated in the drawings.

Unless defined otherwise, all terms (including technical and scientific terms) used in this specification have the same meaning as generally understood by those skilled in the art to which the present disclosure pertains. In addition, the terms defined in commonly used dictionaries should be interpreted as having a meaning consistent with their meaning in the context of the relevant technology, and are explicitly defined herein, unless they would be interpreted in an idealized or overly formal sense.

It should be understood that the term such as “include” or “have” is intended to specify the presence of features, numerals, steps, operations, components, parts described in this specification, or combinations thereof, but do not preclude the presence or addition of one or more other features, numerals, steps, operations, components, parts, or combinations thereof.

A panel material for automotive door moldings is composed of a single stainless steel panel material of 0.4 to 0.7 T that may be processed into a desired shape by surface treatment, and is usually made of 400 series stainless steel, which is made of ferrite.

The panel material for the automotive door moldings using the 400 series stainless steel has the advantage of increasing gloss by adding a separate skin pass process after cold rolling, but due to low tensile strength and elongation, there is a problem with harsh bending due to fine cracks on the processed surface during forming and bending processing required for the manufacturing process of the automotive door moldings. In addition, there are many problems such as surface discoloration due to low corrosion resistance.

Therefore, in order to solve these problems, the bonding panel material for automotive door moldings according to the present disclosure may produce a bonding panel material that utilizes the advantages of two types of steel by bonding stainless steel panel materials with different characteristics.

Hereinafter, the embodiments of the present disclosure will be described in detail with reference to the accompanying drawings.

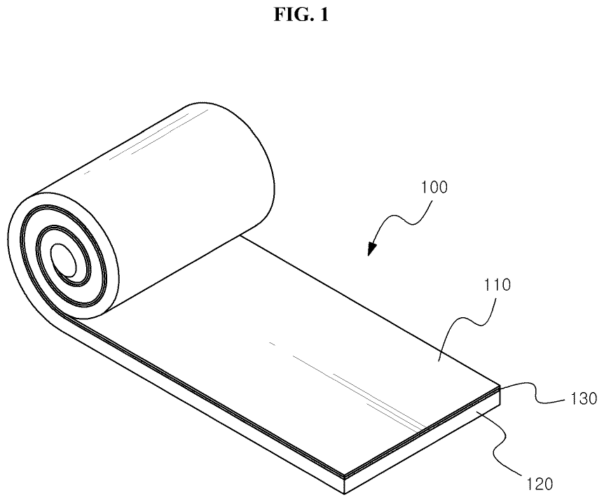

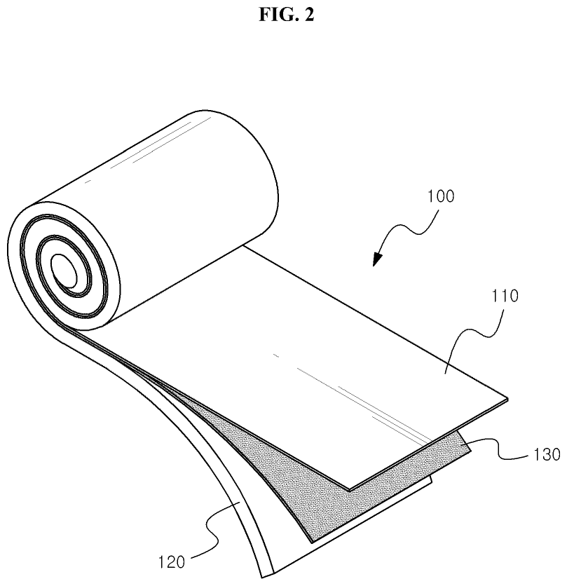

FIG. 1 is a diagram illustrating a structure of a bonding panel material 100 for automotive door moldings according to an embodiment of the present disclosure, and FIG. 2 is a diagram illustrating a state in which a surface material 110 and a base material 120 of the bonding panel material for automotive door moldings according to an embodiment of the present disclosure are bonded with an adhesive.

As shown, the bonding panel material 100 for automotive door moldings according to an embodiment of the present disclosure includes the surface material 110, the base material 120, and an adhesive layer 130.

The surface material 110 is formed to have a preset thickness and area, and is made of a stainless steel panel material having non-magnetism. Specifically, the surface material 110 is made of 300 series stainless steel, which is an austenite series, and has a certain level or higher of elongation, and is a material having relatively stronger corrosion resistance than the base material 120 described below.

The base material 120 is attached to a back surface of the surface material 110 and is made of a stainless steel panel material having magnetism as a material having relatively lower corrosion resistance or elongation than the surface material 110.

Specifically, the base material 120 is made of the 400 series stainless steel, which is a ferrite type having magnetism, unlike the surface material 110, and is formed relatively thicker than the surface material 110.

That is, the surface material 110 is bonded based on the base material 120 to form a thin surface, forming the bonding panel material 100 for automotive door moldings.

Meanwhile, the adhesive layer 130 is positioned between the surface material 110 and the base material 120, and serves to bond the base material 120 to the surface material 110.

In this embodiment, the adhesive layer 130 may be directly applied to one surface of the base material 120 or the surface material 110 or attached in a film form to adhere the base material 120 and the surface material 110 to each other, and the base material 120 and the surface material 110 may be stably bonded by pressure and heat while being stacked.

Usually, in the case of the surface material 110, peeling occurs after a certain period of time when bonded with a conventional adhesive, and accordingly, there is a problem that it is difficult to maintain stable bonding.

However, in the present disclosure, the adhesive layer 130 uses an adhesive having a bonding force of 200N or more in a peel test, so that problems such as peeling during forming or bending may be suppressed, and additionally, it is desirable to produce the adhesive layer 130 to maintain a bonding force of 300N or higher so that the adhesive layer 130 may withstand more severe processing such as reverse bending.

The overall process of bonding the surface material 110 and the base material 120 by the adhesive layer 130 will be described later.

The bonding panel material 100 for automotive door moldings according to the present disclosure configured in this way is further processed to change its shape in the bonded state as described above, and may be stably processed by folding the surface material into a shape forming an outer surface.

In particular, in the bonding panel material 100 for automotive door moldings according to the present disclosure, the surface material 110 has characteristics of relatively greater elongation than the base material 120, and expands together when folding in a direction toward the base material 120 so that the surface material 110 may maintain the surface condition without being damaged.

The bonding panel material of the present disclosure configured in this way is formed in a state in which the base material 120 and the surface material 110 are bonded, unlike a panel material made of a single material of the 400 series stainless steel, which is a form mainly used in the past, and thus may have both the characteristics of the 300 series stainless steel and the 400 series stainless steel.

In particular, the bonding panel material 100 according to the present disclosure is configured such that the base material 120 is made of the 400 series stainless steel panel material, thereby maintaining the characteristics of a single 400 series stainless steel panel material used in the past, while the surface material 110 is made of the 300 series stainless steel panel material, thereby having relatively high elongation, tensile strength, and yield strength.

That is, the present disclosure is configured to have both the characteristics of the 300 series stainless steel and the characteristics of the 400 series stainless steel.

As described above, the bonding panel material according to the present disclosure is not simply made of one type of panel material, but is formed by bonding the 300 series stainless steel panel material and the 400 series stainless steel panel material to form a single panel material, so the bonding panel material has a relatively low processing cost compared to the 400 series stainless steel panel material for automobiles that has undergone multiple skin pass processes used in the past, and has the advantage of being able to be processed stably due to high elongation, tensile strength, and yield strength when processed into a desired shape, and excellent corrosion resistance.

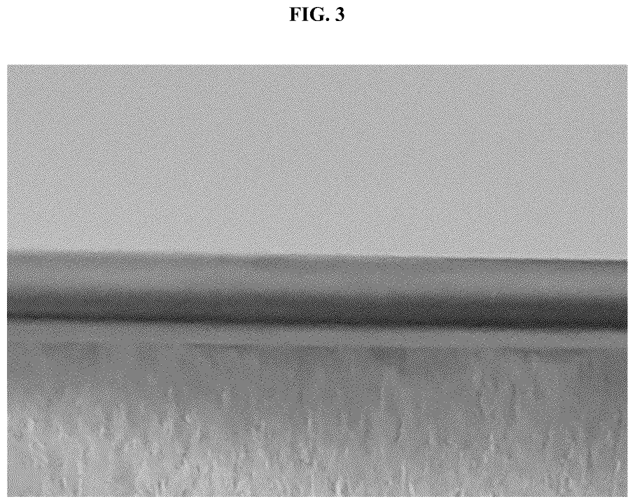

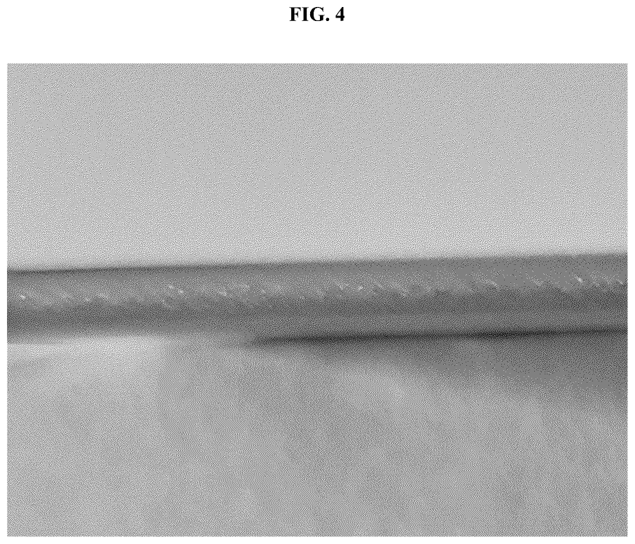

Next, the characteristics of the 300 series stainless steel panel material and the 400 series stainless steel panel material according to the present disclosure will be independently described with reference to FIGS. 3 and 4.

FIG. 3 is a diagram illustrating a state in which the 300 series stainless steel panel material is bent in the bonding panel material 100 for automotive door moldings according to an embodiment of the present disclosure, and FIG. 4 is a diagram illustrating a state in which the 400 series stainless steel panel material is bent in the bonding panel material 100 for automotive door moldings according to an embodiment of the present disclosure.

First, looking at FIG. 3, the 300 series stainless steel panel material is bent, which corresponds to the surface material 110 in the present disclosure.

The surface material 110 has an elongation of approximately 50%, has relatively higher elongation and tensile strength than the base material 120, and has a characteristic of being strong against processing shock. In particular, the 300 series stainless steel has strong corrosion resistance, so it shows a relatively strong appearance against damage or corrosion from the outside, and is made of a material suitable for an exterior material.

Accordingly, as shown in the drawing, even when the 300 stainless steel panel material is processed by zero bending and bent in a completely folded form, the 300 stainless steel panel material expands at the corresponding position to maintain the surface condition and is not damaged.

The surface material 110 is preferably made of any one among the stainless steel grades STS304, STS304L, or STS316L, and in this embodiment, STS304L, which is relatively inexpensive and contains Ti (titanium), is used.

In addition, the surface material 110 may be formed to have a thickness of 0.1 mm to 0.3 mm. This is to have a thin thickness compared to the base material 120 described later so as to minimize the weight of the bonding panel material 100 for automotive door moldings according to the present disclosure, and to position the surface material 110 at a position where deformation occurs a lot during subsequent processing.

In addition, a hairline may be processed on the surface of the surface material 110, or various surface finishing processes such as vibration, bead blast, and embo may be performed.

In this way, the surface material 110 shown in FIG. 3 is relatively easy to process due to the characteristics of the material, and the surface may be processed later.

Meanwhile, looking at FIG. 4, the 400 series stainless steel panel material is in a bent state, and corresponds to the base material 120 in the present disclosure.

The base material 120 is attached to the back surface of the surface material 110 and has an elongation of about 20 to 30%, which is relatively lower than the surface material 110, and has a weak characteristic to processing shock, but has magnetism and may be manufactured at a low cost. In particular, in the case of the 400 series stainless steel, since the elongation is low, it is advantageous to form a frame inside rather than being disposed on the surface.

However, since the 400 series stainless steel panel material is a material with magnetism, it has an advantage in positioning using magnetism during additional processing, and has an advantage in having a certain level or higher of strength, but has a disadvantage of requiring an additional skin-pass process to perform gloss treatment due to low glossiness.

When the base material 120 is deformed to a certain level or higher, it is damaged due to low elongation, and in particular, when the base material 120 is processed with zero bending as shown and bent in a completely folded form, cracks occur on the surface.

The base material 120 is preferably made of any one among the stainless steel grades STS409, STS430, STS436, or STS441, and in this embodiment, STS409 is used.

In addition, the base material 120 may be formed to have a thickness of 0.3 mm to 0.7 mm. This is to have a thicker thickness than the surface material 110, and to maintain a certain level of rigidity while allowing the surface material 110 to be positioned at a position where deformation occurs a lot during processing of the bonding panel material 100 for automotive door moldings.

In this way, the 300 series stainless steel panel material and the 400 series stainless steel panel material each have different characteristics, and by bonding the 300 series stainless steel panel material and the 400 series stainless steel panel material as the surface material 110 and the base material 120, the bonding panel material 100 of the present disclosure is configured.

As described above, in this embodiment, the surface material 110 may be STS304L, and the base material 120 may be STS409, which may be selected by considering the yield strength, the tensile strength, and the elongation based on the table derived through the Posco Mill Test Certificate as illustrated in Table 1 below.

TABLE 1

| | Austenite series | | | Ferrite series | | |
|---|---|---|---|---|---|---|
| Division | 304 | 304L | 316L | 409 | 430 | 430J1L |
| Yield Strength | 298 | 287 | 272 | 243 | 326 | 319 |
| Tensile Strength | 668 | 628 | 578 | 394 | 504 | 463 |
| Elongation | 52 | 52 | 58 | 37 | 27 | 34 |

Based on the above-described Table 1, the surface material 110 and the base material 120 according to the present disclosure may be made of stainless steel having different thicknesses and characteristics.

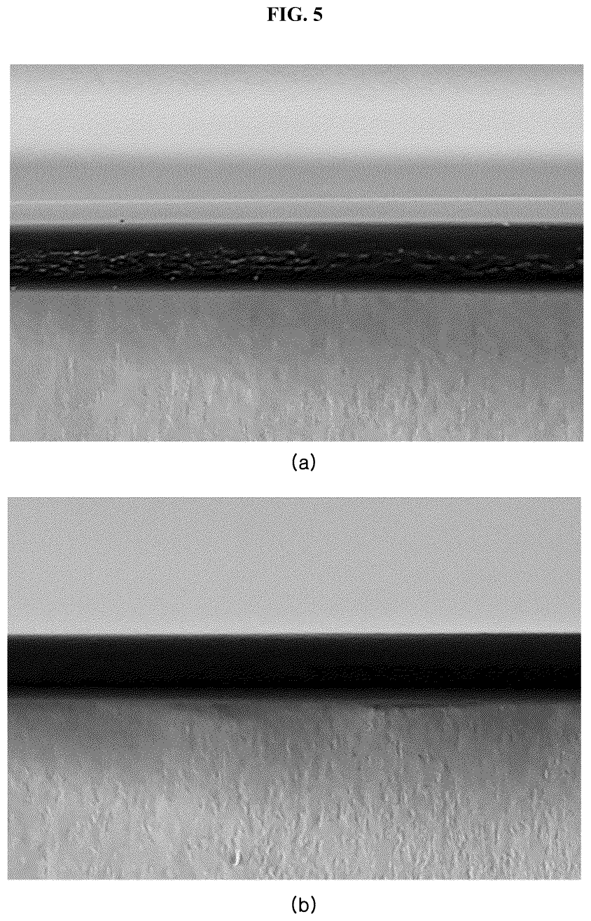

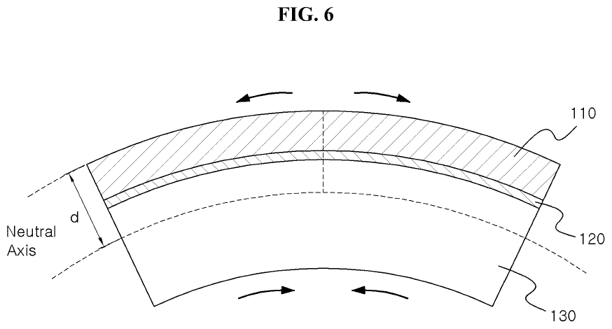

Next, referring to FIGS. 5 and 6, the bonding panel material to which the base material 120 and the surface material 110 are bonded in the bonding panel material 100 for automotive door moldings according to the present disclosure will be examined as follows.

FIG. 5 is a diagram illustrating a difference between a product made of the bonding panel material for automotive door moldings according to an embodiment of the present disclosure and a product made of a conventional 400 series stainless steel single panel material by bending each of the products, and FIG. 6 is a diagram illustrating a detailed state of deformation during bending of the bonding panel material 100 for automotive door moldings according to an embodiment of the present disclosure.

Referring to the drawings shown, the bonding panel material 100 for automotive door moldings is a single panel material made of the 400 series stainless steel panel material, and a photo of the bonding panel material according to the present disclosure being bent, and when the single panel material is made, cracks occur on the surface when bent to a certain degree or higher.

Specifically, FIG. 5A is a photo of stainless steel for automotive door moldings made of the 400 series stainless steel panel material being bent, and when deformation exceeding elongation occurs, cracks occur on the surface or damage occurs.

In this case, the 400 series stainless steel panel material exhibits magnetism and has a certain level or higher of hardness, so it is suitable as a material for positioning or maintaining a shape during processing, but there is a problem that processing is difficult due to low elongation for additional processing.

In addition, in the case of the automotive door moldings that are usually made of only the 400 series stainless steel panel material, STS430J1L is mainly used. The 400 series stainless steel panel material is generally less expensive than the 300 series stainless steel panel material in terms of raw material cost. However, to be used for automotive door moldings, the skin pass processes of controlling the surface gloss should be additionally performed 3 to 5 times, which leads to a significant increase in actual costs.

In contrast, as shown in FIG. 5B, when the bonding panel material 100 for automotive door moldings according to the present disclosure is made of the surface material 110 and the base material 120 formed of the bonding panel materials, each material has its own characteristics.

In particular, when the base material 120 is bent inward, the surface material 110 may expand and maintain the surface condition without being damaged.

Specifically, as shown in FIG. 6, the surface material 110 is bonded to the upper portion of the base material 120, but the base material 120 is formed relatively thick, so that the center line of the bonding panel material is positioned on the base material 120.

By the thickness difference between the surface material 110 and the base material 120, a distance d at which the surface material 110 is positioned from the center line is adjusted, and the surface material 110 is positioned at a position where a relatively large expansion occurs.

That is, the surface material 110 is positioned on the surface at a distance d from the center line of the bonding panel material, so that even when a relatively large expansion occurs, the surface material 110 may be deformed by high elongation and may maintain the surface condition.

In this way, the bonding panel material 100 for automotive door moldings according to the present disclosure is relatively easier to process than a single panel material made only of the 400 series stainless steel panel material, and may have excellent corrosion resistance due to the characteristics of the 300 series stainless steel panel material.

In particular, the bonding panel material 100 for automotive door moldings according to the present disclosure is processed into a desired shape through an additional process in a state in which it is manufactured as a bonding panel material.

The bonding panel material 100 for automotive door moldings according to the present disclosure may be used for the automotive moldings during the additional process, and various methods are used when manufacturing the automotive moldings, and a door belt method or a door frame method may be used.

This method is to roll-form the bonding panel material 100 for automotive door moldings and to bond a separate thermoplastic plastic (polyvinyl chloride (PVC)), thermo plastic elastomer (TPE), etc., through high-frequency induction heating, and then perform processes such as shearing, banding, and notching.

In addition, in contrast, a processing method through an insert injection method of Quarter Glass is used. This is a method of inserting a bonding panel material 100 for automotive door moldings processed by pressing into the mold and then injecting thermoplastic plastic (PVC) to bond the bonding panel material 100, and fixing the position of the bonding panel material 100 for automotive door moldings by planting a magnet inside the mold.

Therefore, in the case of manufacturing a vehicle molding through the above-described method, it is relatively easy to manufacture using a material having magnetism, but there is a problem that the processability of the 400 series stainless steel having magnetism is relatively lower than that of the 300 series stainless steel.

However, by manufacturing the bonding panel material 100 for automotive door moldings of the present disclosure by bonding the surface material 110 of the 300 series and the base material 120 of the 400 series, the metal finishing material has a certain level of magnetism and may fix the position through the magnet during additional processing.

In addition, when banding or press processing above a certain level is performed, the surface material 110 with relatively high elongation is positioned on the outside, so that cracks may be prevented from occurring on the surface.

That is, the present disclosure relates to the bonding panel material 100 to which the base material 120 made of the 400 series stainless steel panel material with magnetism and the surface material 110 made of the 300 series stainless steel panel material with non-magnetism are bonded, and when manufacturing the automotive door moldings, it is possible to simply perform the molding processing process through the base material 120 having magnetism while preventing cracks from occurring on the surface through the large elongation characteristic of the surface material 110.

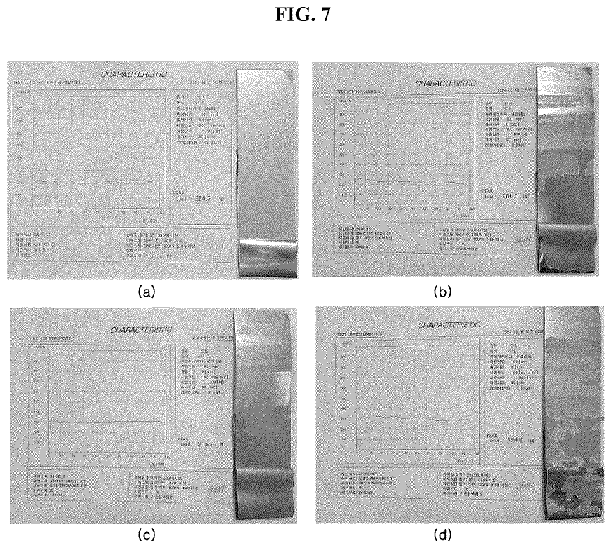

Next, referring to FIG. 7, it may be seen that the bonding panel material according to the present disclosure has an adhesive strength higher than a preset level.

FIG. 7 is a diagram illustrating the results of an adhesive strength test of the bonding panel material according to the embodiment of the present disclosure.

The bonding panel material 100 according to the present disclosure is configured to be bonded by including a separate adhesive layer 130 between the surface material 110 and the base material 120, but may have durability comparable to a single 400 series stainless steel panel material by maintaining the bonding strength higher than a certain level.

Specifically, referring to the drawing shown in FIG. 7, it may be confirmed that the peak load value of the measured value exceeds 200 [N] as a result of the bonding strength test (peel test) of the bonding panel material of the present disclosure.

It can be seen that, even if the base material 120 and the surface material 110 of the present disclosure are formed in the form of the bonding panel material 100 bonded by the adhesive layer 130, the base material 120 and the surface material 110 have a strength similar to that of a plate material made of an actual single material, and accordingly, it may be seen that there is no problem with the durability of the bonding panel material.

As described above, the bonding panel material according to the present disclosure has been examined, and this bonding panel material has excellent processability compared to the single panel material used in the past, and may stably maintain durability due to high elongation and tensile strength.

In addition, in the case of the panel material used for the automotive door molding, an additional gloss control process and a coloring process for controlling color may be performed, and in this process, the bonding panel material according to the present disclosure may be performed relatively cheaply and quickly compared to the 400 series stainless steel panel material used in the past.

First, referring to the gloss control process as a standard, in the case of the 400 series stainless steel single panel material used in the past, the skin pass process should be additionally performed based on STS430J1L to obtain the desired glossiness.

In particular, in the case of the 400 series stainless steel, although there is the skin pass process in the production process, the high-gloss surface may be obtained by performing an additional process 3 to 5 times.

In contrast, in the case of the bonding panel material 100 of the present disclosure, the surface material 110 itself is made of STS304, which is the 300 series thin panel material stainless steel, and may have gloss through a simple heat treatment process after rolling. Of course, an additional polishing process may be performed when desired, but a certain level or higher of glossiness may be generated through simple heat treatment alone.

That is, the bonding panel material 100 using the 300 series stainless steel as the surface material 110 and the 400 series stainless steel as the base material 120 as in the present disclosure may have a certain level or higher of gloss even without performing a separate polishing process.

Next, the difference between the bonding panel material 100 of the present disclosure and the existing 400 series single panel material with respect to the coloring process will be described.

In this case, the color is implemented by depositing titanium ions or chromium ions according to the color during the coloring process of the surface material 110, and the surface material 110 uses the 300 series stainless steel panel material.

For example, when the color of the surface material 110 is gold, the surface material 110 is deposited using nitrogen gas and titanium in a closed space, black uses carbon gas and chromium, and bronze color is implemented using a mixed gas of carbon and nitrogen and titanium.

In this way, the bonding panel material 100 for automotive door moldings of the present disclosure may implement color through a separate coloring process on the surface material 110.

Generally, the coloring process is performed using a vacuum deposition method (physical vapor deposition (PVD)) in which a panel material is inserted into a closed space and deposited, or a nanoceramic coating (nano ceramic coating (NCC)) method.

When the coloring process is performed using the vacuum deposition method, the target is loaded into a vacuum chamber of a preset size, and coloring is performed through a deposition process after making it into a high vacuum state.

In this case, in the present disclosure, when loading the panel material into the vacuum chamber, it is wound in a coil shape, so that a relatively large amount of the panel material may be colored compared to the volume.

Here, in the present disclosure, instead of loading the entire bonding panel material, only the surface material 110 is wound and injected, so that a length of up to 2000 m (based on 0.15 t) or more may be colored at once.

In contrast, in the case of the single panel material of the 400 series stainless steel, there is a problem in that it is difficult to roll and load due to the thickness of the panel material itself, and even when rolled, the overall length itself is short, so that coloring may be performed only for a relatively short length compared to the method of coloring only the surface material 110 as in the present disclosure.

In the vacuum deposition process, the exhaust time for achieving a vacuum inside the vacuum chamber is substantially the same, resulting in a difference in the length of material that may be colored within the same time period. Consequently, coloring only the surface material 110 allows for processing a greater length compared to coloring the entire bonding panel material.

Meanwhile, when the coloring process is performed using a nanoceramic coating method, the surface material 110 is relatively thinner than the single panel material of the 400 series stainless steel, so energy consumption is reduced and the production speed increases accordingly.

In other words, the surface material 110 and the single panel material of the 400 series stainless steel, which are the coloring targets, have different thicknesses, and accordingly, a difference in productivity occurs in the coloring process.

In addition, since coating using a slot die is possible when only the surface material 110 is coated, it has a productivity of more than four times that of the currently used spray coating and may perform high-quality coating.

The geometric structure and physical properties of the bonding panel material 100 for automotive door moldings according to an embodiment of the present disclosure have been described above, and the process for manufacturing the bonding panel material 100 for automotive door moldings as described above will be described below.

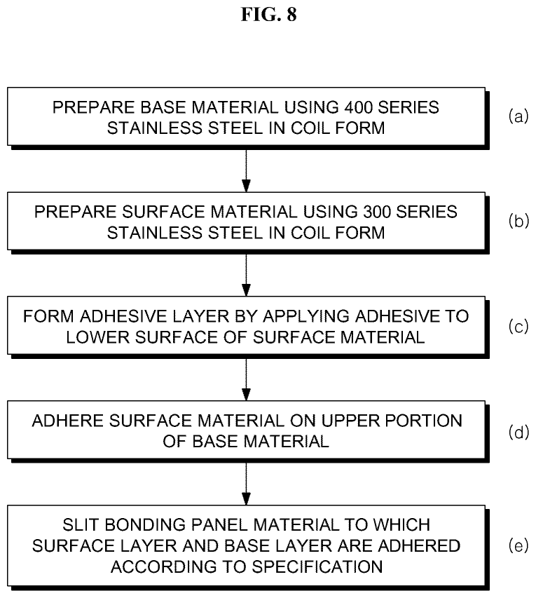

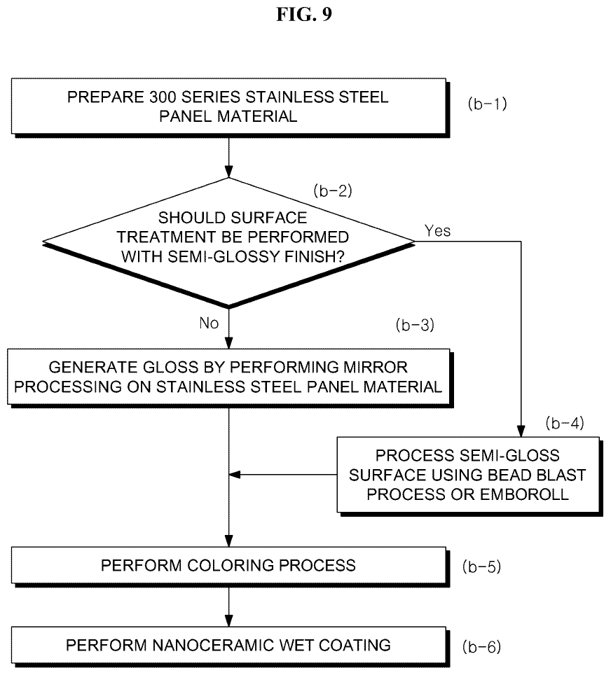

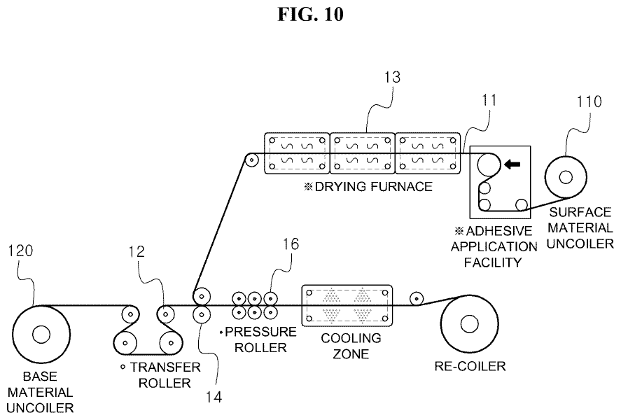

FIG. 8 is a diagram sequentially illustrating the entire manufacturing process of the bonding panel material 100 for automotive door moldings according to an embodiment of the present disclosure, FIG. 9 is a diagram illustrating a detailed process for manufacturing the surface material 110 in the manufacturing process of FIG. 8, and FIG. 10 is a diagram schematically illustrating a device for manufacturing the bonding panel material 100 for automotive door moldings of FIG. 9.

Looking at the overall manufacturing process of the bonding panel material 100 for automotive door moldings according to the present disclosure, first, step (a) of manufacturing the base material 120 using the 400 series stainless steel panel material, which is a ferrite type, is performed.

The base material 120 is manufactured into a flat shape with a preset thickness using the 400 series stainless steel panel material. Here, the base material 120 has a thickness of 0.3 mm to 0.7 mm and is manufactured in a form in which it is rolled up by a separate roller in an extruded state.

That is, as described above, the base material 120 is manufactured into a flat shape with a preset thickness and rolled up along the longitudinal direction.

As shown in FIG. 10, the base material 120 is rolled up and transported along a preset transport path by a separate transport roller 12. In this case, the transport roller heats the base material 120 to a temperature above a certain level so that it may be stably bonded by the adhesive layer 130 when bonded to the surface material 110 later.

Next, step (b) of preparing the surface material 110 with the 300 series stainless steel panel material, which is an austenite type, is performed.

The surface material 110 is made of a panel material having a certain thickness like the base material 120, but unlike the base material 120, it is made of the 300 series stainless steel panel material.

Specifically, the surface material 110 is formed to have a thickness of 0.1 mm to 0.3 mm, has an elongation of about 50%, and may be made of any one among the stainless steel grades STS304, STS304L, STS304J1, STS316, or STS316L.

In this embodiment, the surface material 110 is manufactured in the form of a thin sheet like the base material 120, stored in a wound state, and then the wound portion is recoiled and transported so that it may be bonded to the base material 120.

Thereafter, a step (c) is performed to form an adhesive layer 130 to bond the surface material 110 and the base material 120.

In the step (c), the adhesive layer 130 is formed between the surface material 110 and the base material 120 and is configured to be mutually bonded, so it is formed by being applied to at least one of the back surface of the surface material 110 or the upper surface of the base material 120.

In this embodiment, as shown in FIG. 10, it is applied to the lower surface of the surface material 110 and then dried to form the adhesive layer 130.

Here, the adhesive layer 130 is formed in a form of being applied to the lower surface through a separate application facility 11 provided on the transport path of the surface material 110, and is then transported and bonded to the base material 110. In this case, the surface material 110 may pass through a separate drying furnace 13 provided on the transport path, and may be transported while undergoing an additional drying process in which the adhesive layer 130 is applied.

In this way, after the step (c) of forming the adhesive layer 130 on the upper surface of the base material 120, the step (d) of bonding the base material 120 and the adhesive layer 130 is performed.

In the step (d), the adhesive layer 130 is positioned between the surface material 110 and the base material 120 and bonded to each other to manufacture the bonding panel material 100.

Specifically, in the step (d), as shown in FIG. 10, the base material 120 and the surface material 110 are mutually adhered and transported through a separate bonding roller 14 provided downstream of the transport roller 12 on the transport path.

In this case, the surface material 110 is transported independently from the base material 120, and is transported so as to be connected and combined on the transport path of the base material 120 at a downstream portion according to the transport direction.

In the present embodiment, the surface material 110 is independently transported after the adhesive layer 130 is formed on the lower surface, and is laminated on the upper portion of the base material 120.

That is, the surface material 110 and the base material 120 are each wound in a roll type as described above, and are transported by a plurality of rollers, and a part of the transport path is integrated and laminated. The transport and bonding are simultaneously performed via the bonding roller 14 while the surface material 110 is laminated on an upper portion of the base material 120.

Here, the bonding roller 14 may be heated to a certain level of temperature, and the heating and pressurization may be performed simultaneously when bonding the base material 120 and the surface material 110.

In this way, the base material 120 and the surface material 110 are transported to the bonding panel material 100 in a laminated state via the bonding roller 14 and pressurized via the pressure roller 16 and bonded to each other.

Thereafter, the base material 120 and the surface material 110 that passed through the pressure roller 16 are transported to a completely adhered state via a separate cooling zone 18 in a bonded state, and then recoiled and received again.

Next, the step (e) of processing the bonding panel material to which the base material 120 and the surface material 110 are bonded into a preset shape is performed.

The step (e) is a process of cutting the bonding panel material according to the intended use, and slitting is performed according to the preset size and specifications.

The bonding panel material 100 according to the present disclosure is used for automotive door moldings, and may be cut to a shape and specifications appropriate for the size and used accordingly.

In particular, after the bonding panel material 100 according to the present disclosure is slit into the automotive door moldings, various methods are used during the actual molding processing, and the door belt method, the door frame method, or the insert injection method of quarter glass may be used.

This method bonds the bonding panel material 100 for automotive door moldings with a separate thermoplastic plastic (polyvinyl chloride (PVC)) or thermo plastic elastomer (TPE) by high-frequency induction heating, and then performs processes such as shearing, banding, and notching, and also performs processes such as insert injection method using a mold after press processing.

Therefore, when manufacturing automotive moldings through the above method, even when the surface material 110 is deformed, the surface may be maintained in a stable state, and at the same time, the position may be stably fixed during molding processing through the magnetism characteristics of the base material 120.

By mutually bonding the surface material 110 having a preset area and the base material 120 attached to the back surface of the surface material 110, the bonding panel material 100 for automotive door moldings of the present disclosure manufactured through the above process may have the excellent durability, the elongation, and the tensile strength which are characteristics of the 300 series stainless steel, and may have magnetism, which is a characteristic of the 400 series stainless steel, and express characteristics such as relatively low production cost in a complex manner.

In addition, the step (b) according to the present disclosure may perform at least one of the gloss control process for controlling the gloss of the surface material 110 and the coloring process for controlling the color of the surface material 110.

Referring to FIG. 9, the gloss control process may control the glossiness by performing mirror processing on the surface through an additional process in advance during the processing of the surface material 110 or a process such as bead blasting, and in this embodiment, it is processed to have a glossiness of about 200 to 300 at an angle of 60°.

Specifically, the gloss control process for the surface material 110 is as follows.

First, a process (b-1) for preparing the 300 series stainless steel panel material is performed. A heat treatment process is performed on the stainless steel panel material. In this case, a selection process for selecting the gloss level of the stainless steel panel material is performed (b-2).

In particular, it is necessary to select whether the gloss level of the surface material 110 will be processed with a standard glossy finish, a semi-glossy finish, or the glossiness itself will be adjusted to a certain degree, before proceeding with the subsequent processes.

Here, the surface material 110 may generally have a certain level or higher glossiness with only simple heat treatment in the case of the 300 series stainless steel panel material, and when a high gloss is required depending on the situation, a mirror process is performed (b-3).

That is, when the surface material 110 is manufactured with the glossy finish, heat treatment and an additional mirror process are performed.

In contrast, when the surface material 110 needs to be surface-treated with the semi-glossy finish, an additional bead blast process or a process using an embossing roll is additionally performed (b-4).

In this way, in the present disclosure, the surface material 110 undergoes the gloss control process before bonding with the base material 120, and may be adjusted to the glossy finish or the semi-glossy finish in the gloss control process.

For example, in the present disclosure, when the surface material 110 has the glossy finish, it has a thickness of 0.1 to 0.2 t for STS304 or STS316, and a separate mirror processing process is performed on one surface. In addition, the base material 120 has a thickness of 0.3 to 0.6 t for STS409, 411, 430, etc., and no separate surface treatment process is performed.

In addition, in the present disclosure, when the surface material 110 is to have the semi-gloss, the surface is treated through a pressurizing process using an additional embossing roll and a bead blasting process so that it has a desired gloss.

In this way, the surface material 110 in the present disclosure may undergo a gloss control process so that it has a desired level of gloss.

Thereafter, the gloss control process is performed, and the surface material 110 is manufactured to have the glossy finish or the semi-glossy finish, and a coloring process is performed (b-5).

Specifically, the coloring process is a process of coloring the surface material 110 using at least one inorganic material, and in the present disclosure, it is performed through vacuum deposition using a physical vapor deposition (PVD) method.

In this case, the color is implemented by depositing titanium ions or chromium ions according to the color during the coloring process of the surface material 110. In this case, the surface material 110 uses the 300 series stainless steel panel material.

For example, when the color of the surface material 110 is gold, the surface material 110 is deposited using nitrogen gas and titanium in a closed space, black uses carbon gas and chromium, and bronze color is implemented using a mixed gas of carbon and nitrogen and titanium.

Subsequently, the surface material 110 on which the coloring process has been performed may undergo additional nanoceramic wet coating (b-6).

By performing the nanoceramic wet coating, the surface of the surface material may be prevented from being contaminated, and it may greatly help in maintaining the durability and gloss of the surface.

In this way, the bonding panel material 100 for automotive door moldings of the present disclosure may implement color through a separate coloring process on the surface material 110.

As described above, the preferred embodiments according to the present disclosure have been reviewed, and the fact that the present disclosure can be embodied in other specific forms without departing from the spirit or scope in addition to the above-described embodiments is obvious to those skilled in the art. Therefore, the embodiments described above are to be regarded as illustrative rather than restrictive, and thus the present disclosure is not limited to the above description, but may be modified within the scope of the appended claims and their equivalents.

### DESCRIPTION OF SYMBOLS

100: Bonding panel material
110: Surface material
120: Base material
130: Adhesive layer
12: Transport roller
14: Bonding roller
16: Pressure roller

What is claimed is:

1. A bonding panel material for automotive door moldings, comprising:
a surface material made of a 300 series stainless steel panel material manufactured to a preset thickness;
a base material made of a 400 series stainless steel panel material that is attached to a back surface of the surface material in a flat shape and has magnetism; and
an adhesive layer positioned between the surface material and the base material to bond the surface material and the base material to each other,
wherein the surface material has a relatively greater elongation than the base material.

2. The bonding panel material of claim 1, wherein the surface material is formed to have a thickness of 0.1 mm to 0.3 mm, and
the base material is formed to have a thickness of 0.3 mm to 0.7 mm.

3. The bonding panel material of claim 1, wherein the surface material is made of any one among the stainless steel grades STS304, STS304L, STS304J1, STS316, or STS316L, and
the base material is made of any one among the stainless steel grades STS409, STS411, STS430, STS436, or STS441.

4. The bonding panel material of claim 1, wherein the surface material expands when the base material is formed or bent toward inwardly, and maintains its surface condition without damage from cracking.

5. The bonding panel material of claim 1, wherein the surface material is made of austenitic stainless steel, and
the base material is made of ferritic stainless steel.

6. The bonding panel material of claim 1, wherein the adhesive is applied to at least one surface of the base material or the surface material or is attached in a film form.

7. The bonding panel material of claim 1, wherein the surface material has an elongation of approximately 50% or more and is made of a material that is relatively more resistant to processing shock than the base material.

8. The bonding panel material of claim 1, wherein the surface material adjusts gloss and color through a separate surface treatment.

9. A manufacturing method of a bonding panel material for automotive door moldings, comprising:
(a) manufacturing a base material with a 400 series stainless steel panel material;
(b) preparing a surface material with a 300 series stainless steel panel material;
(c) forming an adhesive layer by applying an adhesive to either a back surface of the surface material or an upper surface of the base material;
(d) positioning the adhesive layer between the surface material and the base material and bonding the surface material and the base material to each other to manufacture the bonding panel material; and
(e) processing the bonding panel material into a preset size and shape.

10. The manufacturing method of claim 9, wherein the bonding panel material bonded in (d) has a bonding force of 200 N or more.

11. The manufacturing method of claim 9, wherein in (b), at least one of a gloss control process for controlling a gloss of the surface material and a coloring process for controlling a color of the surface material is performed.

12. The manufacturing method of claim 11, wherein the surface material is wound in a roll type during the gloss control process or the coloring process.
